(19) United States
(12) Patent Application Publication
(10) Pub. No.: US 2002/0098742 A1
(43) Pub. Date: Jul. 25, 2002

(54) Power supply attachment mechanism and method

(76) Inventors: Shaun L. Harris, McKinney, TX (US); Eric C. Peterson, McKinney, TX (US)

Correspondence Address: HEWLETT-PACKARD COMPANY, Intellectual Property Administration, P.O. Box 272400, Fort Collins, CO, 80527-2400, US

(21) Appl. No.: 09/769,704

(22) Filed: Jan. 25, 2001

(51) Int. Cl. H01R 4/28

(52) U.S. Cl. 439/761

(57) ABSTRACT

A power supply provides for simplified attachment to a substrate. The power supply has a housing having first surface and a second surface. The first surface intersects the second surface and is substantially perpendicular to the second surface. A printed circuit board is located within the housing and is substantially parallel to the first surface. A first connector is connected to the printed circuit board and extends substantially perpendicular to the printed circuit board and through the first surface. A second connector is connected to the printed circuit board and extends parallel to the printed circuit board and through the second surface. The housing has a protrusion formed thereon that is adapted to be received in a member attached to a substrate. The attachment causes a conductor on the substrate to electrically contact the first connector.

### TECHNICAL FIELD OF THE INVENTION

The present invention relates to connecting a power supply to a substrate and, more particularly, to electrically connecting a power supply to a substrate without the use of cables.

### BACKGROUND OF THE INVENTION

Many electronic devices are equipped with internal power supplies that serve to provide electric power to their electronic components. As electronic devices become more complex and consume more power, their power supplies must be adapted to accommodate the greater power demands. In order to accommodate the greater power demands, many power supplies use a plurality of conductors to conduct current into and out of the power supplies. Thus, each conductor only needs to conduct a small portion of the total current input to or output by the power supply.

In addition to the increased power demands on internal power supplies, many electronic devices require power at a plurality of different voltages. Therefore, many internal power supplies are required to generate several different operating voltages. Each operating voltage requires at least one electrical connector to the power supply. Thus, the increased number of operating voltages required to be generated by an internal power supply increases the number of electrical connections between the internal power supply and electrical components located within the electronic device. As described above, each of the plurality of voltages may have a plurality of conductors associated with it, which significantly increases the number of conductors associated with an internal power supply.

Many internal power supplies are manufactured as individual components that operate within an electronic device. For example, the electronic device may have a housing with the power supply and electronic components located therein. The internal power supply plugs into the electronic components to which it supplies electric power by way of a plurality of cables.

In addition to the electrical connections between the power supply and the electronic components, the power supply must have other connections to receive power as briefly described above. In some applications, power is provided by a conventional wall outlet and is converted by the power supply to voltages that are appropriate to operate the electronic components. For example, the power supply may convert high voltage alternating current to low voltage direct currents. In other applications, the power supply receives direct current power and changes the voltage to a plurality of direct current voltages. For example, the power supply may function as a DC to DC converter wherein it receives a direct current voltage and converts it to a plurality of other direct current voltages for use by the electronic device.

Many power supplies have output voltages that are selected by way of external controls or programming. The external controls may be a plurality of binary data lines that, depending on the voltage levels of the lines, control the output voltages. The power supply may also have outputs that indicate the current flow from the power supply and other diagnostic signals.

As described above, power supplies may have a plurality of electrical connections. These include the above-described connections for input voltage, output voltage, and control signals. Conventional power supplies use connectors having wires or cables attached thereto in order to provide the electrical connections between the power supply and other components. The use of connectors has several problems. For example, the connectors associated with the power supply have to have wires attached to them. The attachment of wires to the connectors presents the possibility that the connectors may be mis-wired, which can damage the power supply or the other components in the electronic device. Another problem with the connectors is that they may be difficult to connect within the confines of a compact electronic device. The difficulty in accessing the connectors increases the assembly and repair time of the electronic device. Yet another problem with the connectors is that they may require wiring to be extended through heat sinks and other mechanical devices associated with the power supply. This decreases the convection and mechanical properties of the power supply.

A need exists for an electronic device or power supply that overcomes some or all of these problems.

### SUMMARY OF THE INVENTION

The present invention is directed toward a power supply that may be electrically connected to an electrically conductive substrate without the use of cabling. The power supply may comprise a housing, a printed circuit board located within the housing, a first connector electrically connected to the printed circuit board, and a second connector electrically connected to the printed circuit board. The housing may comprise a housing first surface and a housing second surface wherein the housing second surface intersects the housing first surface and is substantially perpendicular to the housing first surface. The printed circuit board may be substantially parallel to the housing first surface. The first connector may extend substantially perpendicular to the printed circuit board and through the housing first surface. The second connector may extend substantially parallel to the printed circuit board.

The power supply may be adapted to be electrically and mechanically connected to a substrate. More specifically, the substrate may have a plurality of conductors located thereon that are positioned to electrically contact conductors within the first connector of the power supply when the power supply is positioned adjacent the substrate.

In one embodiment, the substrate may have a member extending therefrom that is adapted to be received by a notch in the housing of the power supply. The member may comprise a detent mechanism that biases the power supply toward the substrate. The use of the member decreases the amount of hardware required to attach the power supply to the substrate.

### BRIEF DESCRIPTION OF THE DRAWING

FIG. 1 is a bottom perspective view of a power supply.

FIG. 2 is a side elevation view of the power supply of FIG. 1 wherein the power supply has been rotated right side up relative to the view of FIG. 1.

FIG. 3 is a side cut away view of the power supply of FIG. 2.

FIG. 4 is a side cut away view of the power supply of FIG. 2 attached to a printed circuit board and a substrate.

### DETAILED DESCRIPTION OF THE INVENTION

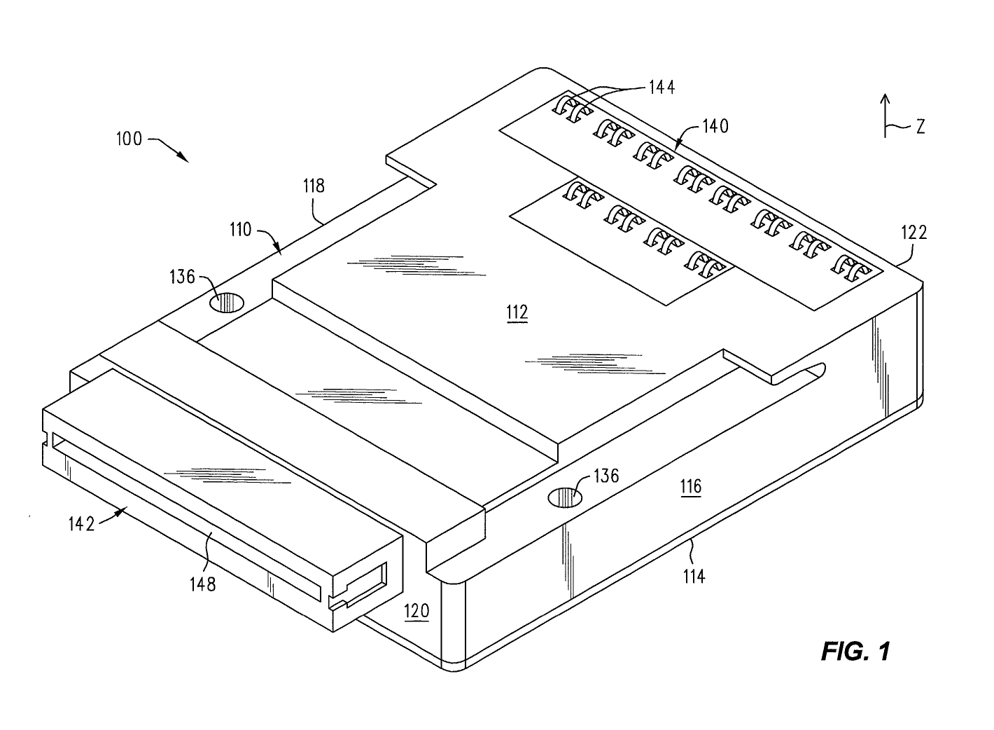

FIGS. 1 through 4, in general, illustrate a power supply 100 that may comprise a housing 110, a printed circuit board 170, a first connector 140, and a second connector 142. The housing 110 may comprise a housing first surface 112 and a housing second surface 120. The housing first surface 112 may be substantially perpendicular to the housing second surface 120. The printed circuit board 170 may be located within the housing 110 and may be substantially parallel to the housing first surface 112. The first connector 140 may be operatively connected to the printed circuit board 170. The first connector 140 may be located adjacent the housing first surface 112 and extend substantially perpendicular to the housing first surface 112. The second connector 142 may be operatively connected to the printed circuit board 170. The second connector 142 may be located adjacent the housing second surface 120 and may extend substantially perpendicular to the housing second surface 120.

FIGS. 1 through 4 also, in general, illustrate an electronic device that may comprise a first substrate 200, a second substrate 208, and a power supply 100. The first substrate 200 may comprise at least one first substrate conductor and an attachment member 220. The second substrate 208 may comprise at least one second substrate conductor and may be positioned substantially parallel to the first substrate 200. The power supply 100 may be located adjacent the first substrate 200 and the second substrate 208 and may comprise a housing 110, a notch 160, a first connector 140, and a second connector 142. The housing 110 may have a housing first surface 112 and a housing second surface 120 wherein the housing first surface 112 is substantially perpendicular to the housing second surface 120. The notch 160 may extend from the housing 110 and may be received by the attachment member 220. The first connector 140 may be located adjacent the housing first surface 112 and may have at least one first conductor 144 associated therewith. The first conductor 144 may be electrically connected to the first substrate conductor. A second connector 142 may be located adjacent the housing second surface 120 and may have at least one second conductor associated therewith. The second conductor may be electrically connected to the second substrate conductor.

Having generally described the power supply 100, it will now be described in greater detail followed by a description of the power supply 100 electrically connected to a printed circuit board and a substrate.

A bottom perspective view of a non-limiting embodiment of the power supply 100 is illustrated in FIG. 1. The power supply 100 may have a housing 110 having a lower surface 112, an upper surface 114, a left surface 116, a right surface 118, a front surface 120, and a back surface 122. The left surface 116 may be substantially similar to the right surface 118. A plurality of holes 136 may pass between the lower surface 112 and the upper surface 114 and may serve to secure the power supply 100 to a substrate, not shown in FIG. 1, as described in greater detail below.

A first connector 140 may extend through the lower surface 112 of the power supply 100. A portion, not shown in FIG. 1, of the first connector 140 may be recessed within the housing 110 and may be attached to a printed circuit board as described below. A second connector 142 may extend through the front surface 120 of the power supply 100. The first connector 140 may serve to connect the power supply 100 to a printed circuit board, not shown in FIG. 1, as described below. In one embodiment of the power supply 100, the second connector 142 attaches to rather than extends through the front surface 120.

The first connector 140 may have a plurality of conductors 144 extending therefrom. The conductors 144 may have spring mechanisms, not shown, associated therewith that bias the conductors 144 in a z-direction Z, which is away from and substantially normal to the lower surface 112 of the housing 110. The application of a force on the conductors 144 in a direction opposite the z-direction Z may cause the conductors 144 to recess within the first connector 140. As will be described in greater detail below, the conductors 144 may serve to electrically connect the power supply 100 to a printed circuit board or other substrate device, not shown in FIG. 1, without the need of other connectors or cabling.

The second connector 142 may have a slot 148 formed therein. The slot 148 may have a plurality of conductors, not shown, located therein and may serve to receive a printed circuit board, not shown in FIG. 1. More specifically, conductors on the printed circuit board may electrically contact the conductors within the slot 148. Accordingly, the second connector 142 may serve to electrically connect the power supply 100 to a second printed circuit board or other substrate.

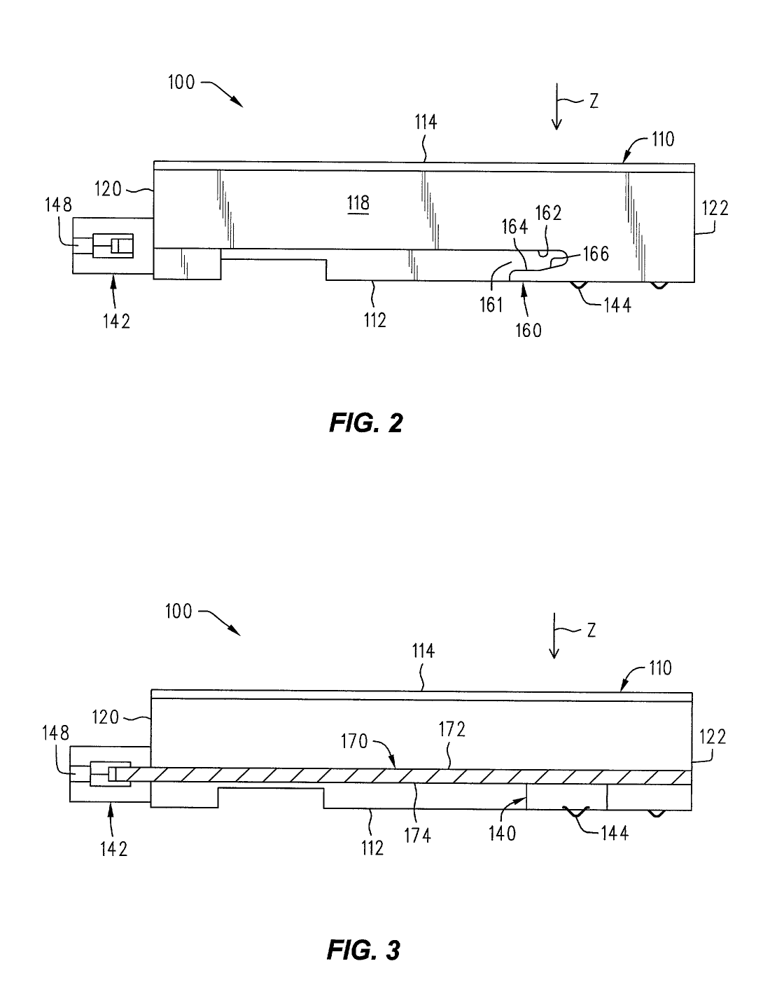

A more detailed view of the right surface 118 of the housing 110 is illustrated in FIG. 2, which is a side elevation view of the power supply 100. It should be noted that the power supply 100 has been rotated from the view of FIG. 2 so that the top side 114 is up. As shown in FIG. 2, a protrusion 160 may be formed from the right surface 118 of the housing 110. As described below in greater detail, the protrusion 160 may serve to secure the power supply 100 to a printed circuit board or other substrate, not shown in FIG. 2. The protrusion 160 may form a notch 161 in the right surface 118 of the housing 110. The notch 161 may be bounded by a portion 162 of the right surface 118 and an upper portion 164 of the protrusion 160. The protrusion 160 may have an upper portion 164 and an inclined portion 166. The protrusion 160 serves to secure the power supply 100 to a substrate with the use of minimal hardware. The left surface 116, FIG. 1, may have a protrusion formed therefrom that is substantially similar to the above-described protrusion 160.

A partial cut away view of the power supply 100 of FIG. 2 is shown in FIG. 3. As shown in FIG. 3, a printed circuit board 170 may be located within the housing 110 of the power supply 100. The printed circuit board 170 may have an upper surface 172 and a lower surface 174. Both the first connector 140 and the second connector 142 may be electrically and mechanically connected to the printed circuit board 170. More specifically, the first connector 140 may be mechanically attached to the lower surface 174 of the printed circuit board 170. Other conventional electrical components, not shown, may also be electrically and mechanically connected to the printed circuit board 170. The printed circuit board 170 may extend substantially parallel to the lower surface 112 and substantially perpendicular to the front surface 120 of the housing 110. This positioning of the printed circuit board 170 facilitates the first connector 140 extending substantially perpendicular to the printed circuit board 170 and the second connector 142 extending substantially parallel to the printed circuit board 170.

As shown in FIG. 3, the first connector 140 may extend through the lower surface 112 of the power supply 100. Accordingly, the first connector 140 will not interfere with any heat sinks which are generally located in the proximity of the upper surface 114 of the power supply 100. A conventional power supply having wired connectors may have to be adapted so that both the heat sink and the connector are located on the upper portion of the power supply. This configuration of a conventional power supply reduces the size and thus, the efficiency, of the heat sink.

The printed circuit board 170 may serve to convert power so as to be usable by an electronic device, not shown in FIG. 3, to which the power supply 100 is associated. For example, the first connector 140 may be adapted to receive electric power and control signals from a first electronic device, not shown in FIG. 3. The first connector 140 may also be adapted to output information pertaining to the operation of the power supply 100. The second connector 142 may be adapted to output several different voltages to a second electronic device, not shown in FIG. 3.

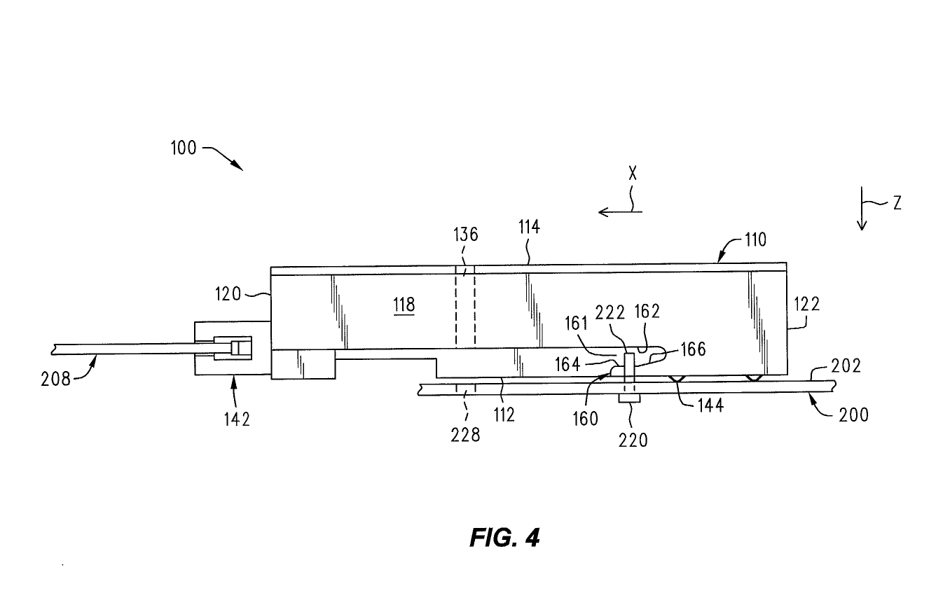

Having described the power supply 100, the power supply 100 electrically connected to a substrate and a printed circuit board will now be described. Referring to FIG. 4, the lower surface 112 of the housing 110 may be located adjacent a substrate 200. More specifically, the lower surface 112 of the power supply 100 may be adjacent or in contact with a top surface 202 of a substrate 200. The substrate 200 may as examples be a printed circuit board or a power plane. A printed circuit board 208 may extend from the second connector 142. The printed circuit board 208 may, as an example, be a mother board or the like used in a computer.

The top surface 202 of the substrate 200 may have a plurality of conductors or the like, not shown, formed thereon. The conductors are located on the top surface 202 so that the conductors 144 extending from the lower surface 112 of the housing 110 are able to contact them. As described above, the conductors 144 may be biased in the z-direction Z, which ensures that the conductors 144 will contact the conductors on the top surface 202 of the substrate 200 when the power supply 100 is placed adjacent the top surface 202 of the substrate 200. Accordingly, no other connectors or cables are required to electrically connect the power supply 100 to the substrate 200.

A securing member 220, sometimes referred to as an attachment member, may extend through the substrate 200. The securing member 220 may have an engagement portion 222 that is received by the protrusion 160. The engagement portion 222 may be biased in the z-direction Z toward the top surface 202 of the substrate 200. For example, a detent mechanism, not shown, may serve to bias the engagement portion 222 toward the top surface 202 of the substrate 200. As the power supply 100 is moved in an x-direction X parallel to the top surface 202 of the substrate 200, the engagement portion 222 contacts the inclined portion 166 of the protrusion 160. This contact causes the power supply 100 to be more forcefully biased against the top surface 202 of the substrate 200. This biasing along with the biasing of the conductors 144 in the z-direction Z assures that the conductors 144 electrically contact the conductors on the top surface 202 of the substrate 200. In addition, the biasing serves to attach the power supply 100 to the substrate 200 with minimal hardware.

A hole 228 may be formed in the substrate 200. The hole 228 may align with the hole 136 passing through the housing 110 of the power supply 100 when the power supply 100 is properly positioned relative to the substrate 200. In one embodiment of the power supply 100, proper alignment occurs when the engagement portion 222 of the securing member 220 receives the inclined portion 166 of the protrusion 160. A fastener not shown, such a screw, may then be placed through the hole 136 in the power supply 100 and the hole 228 in the substrate 200 to secure the power supply 100 to the substrate 200. It should be noted that the substrate 200 may have a plurality of holes formed therein that align with the above-described plurality of holes that may pass through the housing 110 of the power supply 100. Accordingly, a plurality of fasteners may serve to secure the power supply 100 to the substrate 200. It should be noted that as the power supply 100 is moved in the x-direction X the securing member 220 secures the power supply 100 to the substrate 200 and causes the printed circuit board 208 to enter slot 148 and connect to second connector 142.

The conductors on the top surface 202 of the substrate 200 may, as an example, supply forty-eight volts to the power supply 100 by way of the conductors 144. The power supply may in turn output 3.3 volts and other voltages to the printed circuit board 208 by way of the second connector 142. The conductors on the top surface 202 of the substrate 200 may also provide control signals to the power supply 100. For example, the control signals may instruct the power supply to turn off or on. In the event the power supply outputs several different voltages, the control signals may instruct the power supply to turn specific voltages on or off. The conductors may also provide for signals to be transmitted from the power supply 100 to an external processor, not shown. The signals may, as an example, be indicative of the current flow from specific outputs of the power supply 100.

Because all the power and control signals are provided by way of the substrate 200 and thus the conductors 144, no external wiring is required to be connected to the power supply 100. This lack of external wiring provides many benefits over conventional power supplies. For example, during fabrication of the power supply 100, no external cables need to be wired or otherwise manufactured. Accordingly, the device in which the power supply 100 is used does not require any cables to be attached to the power supply 100. This lessens the probability of fault due to a mis-wired cable. It also facilitates the fabrication of the device to which the power supply is used by not requiring a fabricator to have to connect a cable to the power supply 100. The lack of connectors is especially useful in compact devices where the connection of a cable to any electronic component can be rather difficult.

The use of the power supply 100 simplifies the processes of manufacturing and troubleshooting an electronic device. In the example where the printed circuit board 208 is a motherboard or the like used in a computer system, the printed circuit board 208 may be connected to a second substrate, not shown, that serves to transmit data to and from the printed circuit board 208. The addition of the power supply is achieved by sliding the second connector 142 onto the printed circuit board 208. More specifically, the power supply 100 is moved in the x-direction X relative to the substrate 200 so that the connector 142 electrically contacts the printed circuit board 208. This movement of the power supply 100 relative to the substrate 200 causes the protrusion 160 to be received by the securing member 220. When the power supply 100 is secured to the substrate 200, the conductors 144 on the power supply 100 contact the upper surface 202 of the substrate 200. A conventional fastening device, such as a screw, may be placed through the hole 136 to secure the power supply 100 to the substrate 200. In one embodiment of the power supply 100, the friction between the securing member 220 and protrusion 160 alone serves to secure the power supply 100 to the substrate 200.

The substrate 200 of FIG. 4 has been illustrated with a single power supply 100 electrically and mechanically connected thereto. It should be noted that the substrate 200 may be adapted to have several power supplies 100 electrically and mechanically connected thereto. This allows a plurality of printed circuit boards 208 to be used in an electronic device wherein each is connected to an individual power supply 100 which in turn are connected to a single substrate 200.

What is claimed is:

1. A power supply comprising:
a housing comprising a housing first surface and a housing second surface, said housing first surface being substantially perpendicular to said housing second surface;
a printed circuit board located within said housing, said printed circuit board being substantially parallel to said housing first surface;
a first connector operatively connected to said printed circuit board, said first connector being located adjacent said housing first surface and extending substantially perpendicular to said housing first surface; and
a second connector operatively connected to said printed circuit board, said second connector located adjacent said housing second surface and extending substantially perpendicular to said housing second surface.

2. The power supply of claim 1, wherein said housing has a protrusion formed therein, said protrusion forming a notch in said housing.

3. The power supply of claim 2, wherein said notch comprises an open end and a closed end, the size of said open end being greater than the size of said closed end.

4. The power supply of claim 1, wherein said first connector comprises at least one conductor, said at least one conductor being biased in a direction away from said printed circuit board.

5. The power supply of claim 1, wherein said first connector extends through said housing first surface.

6. An electronic device comprising:
a first substrate comprising at least one first substrate conductor and an attachment member;
a second substrate comprising at least one second substrate conductor, said second substrate being positioned substantially parallel to said first substrate;
a power supply located adjacent said first substrate and said second substrate, said power supply comprising:
a housing having a housing first surface and a housing second surface, said housing first surface being substantially perpendicular to said housing second surface;
a protrusion extending from said housing, said protrusion being received by said attachment member;
a first connector located adjacent said housing first surface, said first connector having at least one first conductor associated therewith, said at least one first conductor being electrically connected to said at least one first substrate conductor; and
a second connector located adjacent said housing second surface, said second connector having at least one second conductor associated therewith, said at least one second conductor being electrically connected to said at least one second substrate conductor.

7. The electronic device of claim 6, wherein said attachment member comprises a detent mechanism associated therewith to bias said power supply toward said first substrate.

8. The electronic device of claim 6, wherein said first substrate is a printed circuit board.

9. The electronic device of claim 6, wherein said at least one first conductor has a spring mechanism associated therewith to bias said at least one first conductor toward said first substrate.

10. An electronic device comprising:
a first substrate having a first substrate member extending therefrom;
a second substrate being substantially parallel to said first substrate; and
a power supply means located adjacent said first substrate and said second substrate, said power supply means comprising:
a housing having a protrusion extending therefrom, said protrusion extending substantially parallel to said first substrate, said protrusion being received by said first substrate member;
a first connector means for interfacing said power supply means to said first substrate, said first connector means extending substantially perpendicular to said first substrate; said first connector means having at least one first conductor means for electrically connecting said first connector means to said first substrate; and
a second connector means for interfacing said power supply means to said second substrate, said second connector means extending substantially parallel to and electrically connected to said second substrate.

11. The electronic device of claim 10, wherein said at least one first conductor means has a spring means associated therewith for biasing said at least one first conductor means toward said first substrate.

12. The electronic device of claim 10, wherein said substrate member has a detent means associated therewith for biasing said power supply means toward said first substrate.
